(19) United States
(12) Patent Application Publication
(10) Pub. No.: US 2023/0302383 A1
(43) Pub. Date: Sep. 28, 2023

(54) APPARATUS FOR CONTINUOUSLY FILTERING A SLUDGE SUSPENSION

(71) Applicant: ESS Holding GmbH, Steyr (AT)

(72) Inventors: Alireza Eslamian, Steyr (AT); Martin Schifko, Steyr (AT)

(21) Appl. No.: 18/019,069

(22) PCT Filed: Aug. 4, 2021
(86) PCT No.: PCT/AT2021/060269

§ 371 Date: Jan. 31, 2023

(30) Foreign Application Priority Data
Aug. 5, 2020 (AT) A50657/2020

(51) Int. Cl. B01D 33/23; B01D 33/073

(52) U.S. Cl. CPC B01D 33/23; B01D 33/073; B01D 2201/282

(57) ABSTRACT

Anapparatus for continuously filtering a sludge suspension, having a hollow shaft (2) that is rotatably mounted in a housing (1) and which that is fluidically connected to an inner chamber (6), which is surrounded by a filter membrane (5), of a discoid filter element (3) that radially protrudes from the hollow shaft (2), for removing a filtrate. A higher throughput of the filtrate, independently of the solids content of the sludge suspension to be filtered, is provided by the filter cake thickness and the filtration duration. The the radius (r) of the filter element (3) increases in the circumferential direction from a low pressure radius rᵢ to a high pressure radius rₕ,reducing the free housing cross section.

An apparatus for continuously filtering a sludge suspension, having a hollow shaft (2) that is rotatably mounted in a housing (1) and that is fluidically connected to an inner chamber (6), which is surrounded by a filter membrane (5) of a discoid filter element (3) that radially protrudes from the hollow shaft (2), for removing a filtrate. A higher throughput of the filtrate, independently of the solids content of the sludge suspension to be filtered, is provided by the filter cake thickness and the filtration duration. The radius (r) of the filter element (3) increases in the circumferential direction from a low pressure radius rᵢ to a high pressure radius rₕ, reducing the free housing cross section.

### FIELD OF THE INVENTION

The invention relates to an apparatus for continuous filtration of a sludge suspension, having a hollow shaft which is rotatably mounted in a housing and which is, in order to remove a filtrate, flow-connected to the inner chamber (6), which is surrounded by a filter membrane, of a discoid filter element which radially projects from the hollow shaft, wherein the radius of the filter element increases in the circumferential direction from a low-pressure radius rₗ to a high-pressure radius rₕ in order to reduce the free housing cross-section, and wherein the filter element has a compression section formed from the low-pressure radius rₗ by increasing the radius of the filter element to the high-pressure radius rₕ, and an expansion section formed from the high-pressure radius rₕ by decreasing the radius of the filter element to the low-pressure radius rₗ. It is understood that such an apparatus can also be used to separate other suspensions or filterable mixtures from one another.

### DESCRIPTION OF THE PRIOR ART

An apparatus for filtering a suspension is known from WO2000047312A1. For this purpose, the cavity of a filter element surrounded by a filter membrane is flow-connected to a hollow shaft. If a suspension flows against the filter element, the solid particles of the suspension are retained by the filter membrane, whereas a liquid portion of the suspension flows via the inner chamber of the filter element to the hollow shaft and can be discharged as filtrate. With increasing filtration time, the thickness of the filter cake covering the filter membrane increases, which considerably reduces the filtrate flow and thus the filtration efficiency. With several filter elements mounted one behind the other in the axial direction, the solids content increases in the flow direction of the apparatus. To maintain a constant filtration rate, the pressure on the suspension side can be increased, or the filter cake can be cleaned off the filter membrane at regular intervals. In WO2000047312A1, the cleaning step is made possible by rotating the filter membrane around the hollow shaft. The disadvantage of this, however, is that such a relative movement is not sufficient for cleaning the filter cake, especially in the case of suspensions with a high solids content and in the case of filter cakes that are strongly pressed against the filter membrane, which is why WO2000047312A1 further proposes providing two hollow shafts extending parallel to one another, each with a plurality of filter elements arranged thereon. If the hollow shafts are arranged accordingly, the relative movement of the filter elements arranged on the different hollow shafts can cause mutual shearing of the filter cake located on the filter membrane. Naturally, shearing can only occur if the filter cakes of the respective filter membranes are thick enough for contact to occur between the respective filter cakes, so that the method is only effective after a certain filtration time or filter cake thickness. In addition, only part of the filter cake can be removed by shearing due to the design.

From US20150290564A1 and KR101994066B1 apparatus for continuous filtration of a sludge suspension with a hollow shaft rotatably mounted in a housing, which hollow shaft is flow-connected with symmetrically formed filter elements projecting from the hollow shaft, are known.

### SUMMARY OF THE INVENTION

The invention is thus based on the object of creating an apparatus of the type mentioned at the beginning, which enables a higher throughput of the filtrate independent of the solids content of the suspension to be filtered, the filter cake thickness and the filtration time.

The invention solves the set object by decreasing the radius in the expansion section faster than increasing the radius in the compression section. As a result of this measure, the suspension in the area of the filter element that is set in rotation is subjected to a pressure curve that changes over time, preferably sinusoidally. If the free housing cross-section, i.e. that cross-section in the housing which is not occupied by the filter element, is reduced at a reference point by a rotation of the filter element and thus by a movement of the high-pressure radius towards this reference point, the suspension is compressed at this reference point. This increases the pressure difference between the suspension side and the filtrate side, which promotes rapid filtration of the suspension. During this filtration, the liquid portion of the suspension passes through the filter membrane, enters the inner chamber of the filter element and is discharged via the hollow shaft. The solid particles, on the other hand, are retained by the filter membrane and accumulate thereon as a compacted filter cake, which forms a resistance for the liquid portion of the suspension, as a result of which the filtrate flow subsequently decreases. Due to the design of the filter element according to the invention, a further rotation of the filter element causes an expansion of the free housing cross-section at the reference point, as a result of which the pressure exerted on the suspension decreases. This pressure fluctuation promotes loosening and thus detachment of the filter cake from the filter membrane. In addition, the centrifugal forces caused by the rotary motion of the hollow shaft can be used to support detachment of the filter cake. By increasing and decreasing the pressure according to the invention, consistent filter conditions can be created at the filter element even after a long filtering period. Complete cleaning can be favored by strong turbulence in the suspension. This can be achieved by a rapid pressure drop at the reference point. Such a rapid pressure drop is achieved when the filter element has a compression section formed from the low-pressure radius by increasing the radius of the filter element to the high-pressure radius, and an expansion section formed from the high-pressure radius by decreasing the radius of the filter element to the low-pressure radius, wherein the decrease of the radius in the expansion section is faster than the increase of the radius in the compression section. The relatively slow pressure increase at the reference point allows the filter cake to be sufficiently dewatered before it is cleaned off by the abrupt pressure drop in combination with the rotary motion of the filter element. In the context of the invention, radius means the distance between the point of rotation of the filter element and a circumferential point of the filter element. The filter element has an inner chamber which is surrounded by a filter membrane. Surrounded in this context means that the filter membrane delimits the inner chamber at least in sections.

The apparatus according to the invention can be subjected to basic cleaning in a simple manner at regular intervals as part of maintenance activities. For this purpose, water or another suitable cleaning agent is pumped from the hollow shaft to the inner chamber of the filter elements and then through the filter membrane into the housing of the apparatus. In the process, particularly strongly compressed filter cake residues also detach from the filter membrane, which can be flushed out of the housing together with other suspension residues.

In order to also generate a varying pressure distribution in the axial direction of the apparatus at any time, it is proposed that several filter elements are arranged on the hollow shaft in the axial direction, the high-pressure radii of which are offset from one another in a circumferential direction. Thus, the successive high-pressure radii form a spiral running around the hollow shaft. The pressure differences extending in the axial direction impose turbulence on the suspension, which further improves the cleaning of the filter membranes and thus the filtration efficiency. It has been found that particularly favorable filtration conditions result when the offset of the high-pressure radii between two filter elements following one another in the axial direction is between 1° and 45° each, preferably between 5° and 20° each. The distance between the filter elements arranged in the axial direction can be constant or variable depending on the mixture to be filtered.

In order to increase the throughput of the apparatus without significantly increasing manufacturing costs and also to create improved filtration efficiency, at least two parallel hollow shafts can be provided in the housing, the filter elements of which are offset from one another in the axial direction to form a gap. In principle, it is sufficient that only one of the hollow shafts is designed according to the invention, while the other hollow shaft can also be flow-connected to other filter elements and does not have to be rotatably mounted. As a result of the measures described, varying pressure distributions can also be established in housings with large cross-sections over their entire cross-section. A relative movement of the hollow shafts with respect to each other results in increased turbulence between the filter elements arranged thereon. Advantageously, the filter elements can together form a mixer that ensures homogeneous mixing of the suspension, which further promotes uniform filtration.

In a particularly efficient embodiment of the apparatus according to the invention, it is recommended that the filter elements of the at least two hollow shafts parallel to each other at least partially overlap in the axial direction so that cleaning of a strongly compressed filter cake from the filter membrane is also possible without having to stop the apparatus and thus stop the filtration. This results in mutual shearing of the filter cake between filter elements adjacent in the axial direction during a corresponding rotary movement of the filter elements. Due to the shape of the filter elements according to the invention in combination with the overlapping of the filter elements of the respective hollow shafts, which are staggered with respect to each other, the filter elements can act as a shredder for sludge lumps in the suspension if they are of a suitable nature, which favors further homogenization.

On an industrial scale, continuous cross-flow filtration is usually used. This means that the suspension has to be conveyed along the filter membrane by means of pumps, for example. Especially for suspensions with a high solids content, this requires extremely robust pump systems as well as a high additional energy input so that the suspension can be conveyed over the entire filtration area, i.e. the filter membranes. The arrangement of two hollow shafts parallel to each other with mutually staggered filter elements and at least partially overlapping in the axial direction results in the advantage that the free cross-section between the hollow shaft with the filter elements according to the invention and the other hollow shaft decreases cyclically, so that the offset of the high-pressure radii in the axial direction results in a displacement of the suspension in the axial direction and thus a conveyance of the suspension through the apparatus. As a result, suspensions with a low solids content as well as suspensions with a solids content of up to 98% can be conveyed. Depending on the solids content of the suspension, it may be necessary to adjust the housing diameter as well as the dimensioning of the filter elements. To additionally increase the pressure difference, an additional pump can be provided on the suspension side and/or a vacuum pump on the filtrate side. The displacement effect described can also be used to operate the apparatus according to the invention exclusively with the inherent pressure of the suspension to be filtered, because if the pressure of the suspension to be filtered is sufficient, the filter elements limiting the free cross-section are themselves displaced and thus the hollow shaft is set in rotation. The apparatus can thus be used, for example, for energy-saving filtration of a flowing body of water, wherein the flow of the flowing body of water is used to drive the hollow shaft.

In order to achieve uniform filter ratios over the cross-section of the housing and at the same time enable energy-efficient conveying of suspensions with a high solids content, it is proposed that the hollow shafts with the filter elements arranged thereon are arranged mirrored to one another about a common plane of symmetry. This arrangement allows the suspension to be actively pressed uniformly from filter element to filter element over the cross-section, wherein the cyclically decreasing largest free cross-section between the filter elements and the housing is increased, so that even suspensions with a high solids content that are difficult to convey can be transported in the direction of the outlet without having to rely on pumps or other conveying devices. This also makes it possible to dimension particularly long apparatuses for continuous filtration of suspensions, the length of which was limited in previously known apparatuses due to the energy-intensive conveying when the solids content of the suspension increases with the length of the apparatus. Due to this robust conveying of the suspension, a considerably higher solids content can be realized in the continuous method.

In order for the apparatus according to the invention to be used for making up the sludge, it is proposed that downstream of the filter elements there is a pelletizing device which is driven by the hollow shaft. The pelletizing device can be, for example, a pelletizing plate, which agglomerates the dewatered sludge.

In order to be able to realize filter elements with particularly large diameters and at the same time to facilitate their assembly on the hollow shaft, a filter element can comprise a plurality of filter element segments, which are preferably detachably connected to one another in a form-fitting manner. The filter element segments can be connected to one another, for example, via tongue-and-groove connections extending in the radial direction, which facilitates consecutive arrangement of the individual filter element segments on the hollow shaft for assembly of the filter element. The cavities of the filter element segments can be separated from each other, so that fluid connection of different filter element segments of a filter element can only occur via the hollow shaft. To form the radius of the filter element according to the invention, the filter element segments of a filter element have different geometric designs, wherein the radii of adjacent filter element segments can be substantially the same in the boundary region.

Lightweight and durable filter element segments can be created if they are made of porous plastic. This means that no separate filter membranes need to be provided, since filtration is achieved by the porosity of the plastic. Furthermore, the filter element segments can be formed in one piece. This means that the filter element segments together with any tongue-and-groove joints for connecting a number of filter element segments, with connecting nipples for connecting the filter element segments to the hollow shaft and/or other filter element segment parts form an integral plastic part. For example, polyethylene (PE), polypropylene (PP), polytetrafluoroethylene (PTFE), polyvinylidene fluoride (PVDF), polyurethane (TPU), ethylene vinyl acetate (EVA), polycarbonate (PC), polyamide (PA) and polyethersulfone (PES) can be used as base materials for the production of porous plastics. Synthetic rubbers mixed with urea can also be used for this purpose.

In order to reduce the filter membrane area to be cleaned, it is proposed that the filter membrane has two filter membrane disks arranged parallel to each other at a distance. The filtered suspension enters the inner chamber of the filter element between the filter membrane disks through these filter membrane disks, so that the filter membrane disks preferably extend transversely to the axial direction of the hollow shaft.

To simplify cleaning of the filter element segments, the filter membrane disks can be inserted into a fluid-impermeable base body of the filter element segment. In this way, the filter membrane disks can be removed from the filter element segment and cleaned independently of the base body without having to dismantle the filter element segments or even the filter element from the hollow shaft. The base body is impermeable to fluids, so it does not perform any filtering function and therefore needs to be cleaned much less frequently. The base body can, for example, be made of plastic, in particular natural or synthetic rubbers, whereby a fluid-tight connection is achieved between the base body and the insertable filter membrane disks, which can preferably be inserted radially to the hollow shaft. Another advantage is that this results in particularly gentle mounting of the filter membrane disks, so that sensitive filter materials such as ceramics can be used even at high rotational speeds. A similar effect is achieved if the base body has a metallic core and is covered by plastic.

Although various materials are conceivable in principle as filter membrane disks, particularly robust conditions result if the filter membrane disks are made of porous plastic. For example, polyethylene (PE), polypropylene (PP), polytetrafluoroethylene (PTFE), polyvinylidene fluoride (PVDF), polyurethane (TPU), ethylene vinyl acetate (EVA), polycarbonate (PC), polyamide (PA) and polyethersulfone (PES) can be used as base materials for the production of porous plastics. Synthetic rubbers mixed with urea can also be used for this purpose.

In order to increase the filter performance of the filter membrane disks, it is proposed that the filter membrane disks have a ceramic core. The ceramic cores can be enclosed by a porous plastic, so that the filter performance is further increased and the sensitive ceramic cores are simultaneously protected by the porous plastic against vibrations or the like.

### BRIEF DESCRIPTION OF THE INVENTION

In the drawing, the subject matter of the invention is shown by way of example, wherein:

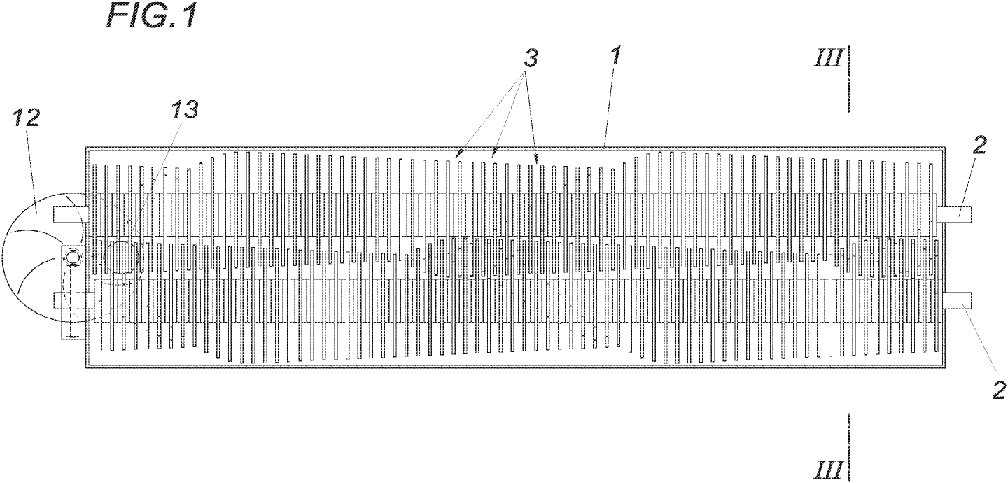

FIG. 1 shows an exposed top view of the apparatus according to the invention,

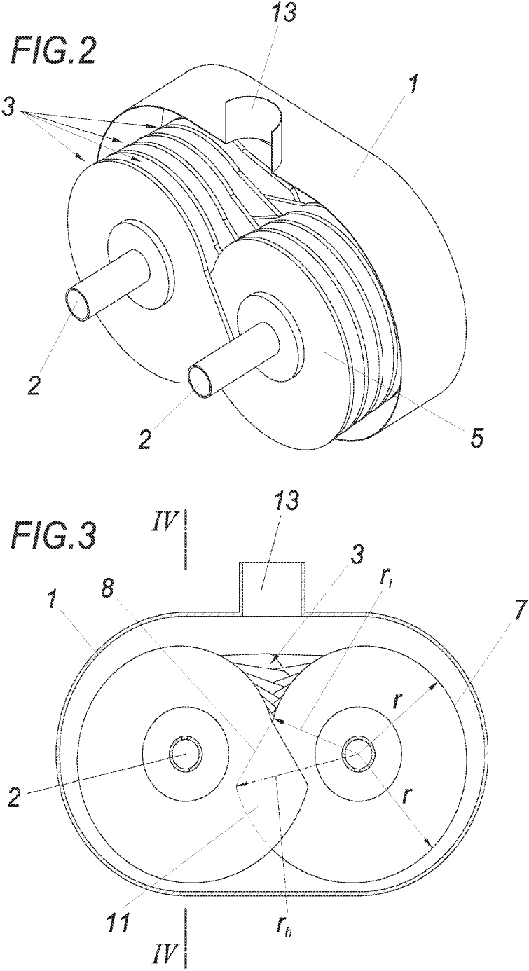

FIG. 2 shows a detailed view of the partially exposed apparatus in perspective view on an enlarged scale,

FIG. 3 shows a section extending along line III-III of FIG. 1 in enlarged scale,

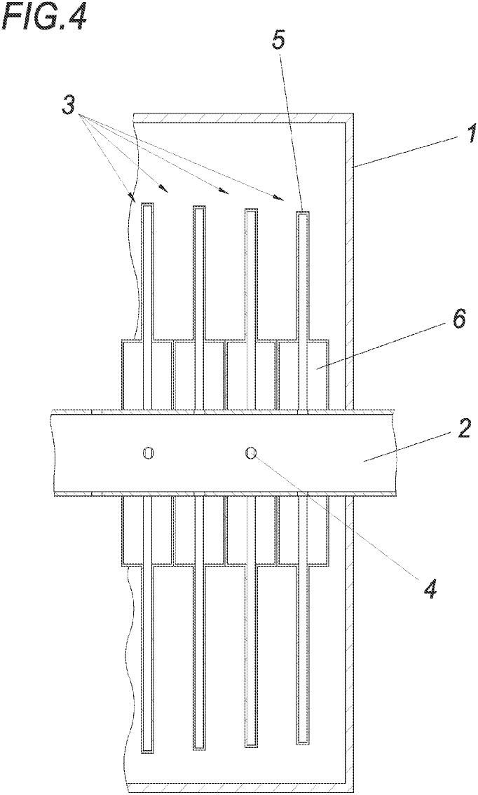

FIG. 4 shows a section along line IV-IV of FIG. 3,

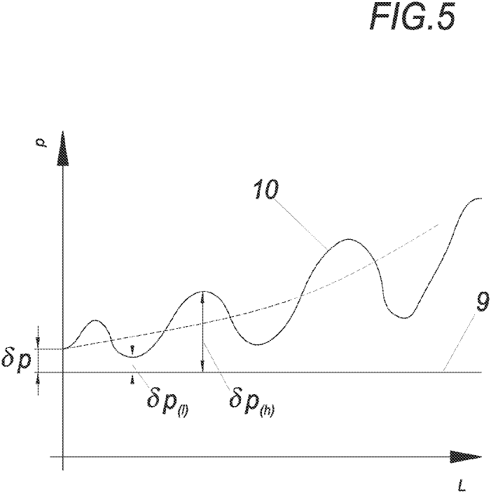

FIG. 5 shows a diagram of the pressure curve in the suspension along an axial flow line and in the filtered-out filtrate in the axial direction of the apparatus,

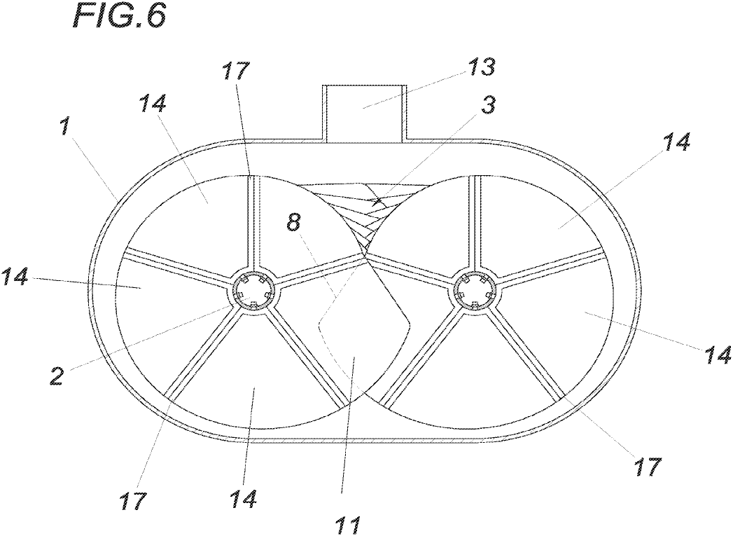

FIG. 6 shows a sectional view, corresponding to FIG. 3, of a second embodiment of the apparatus according to the invention,

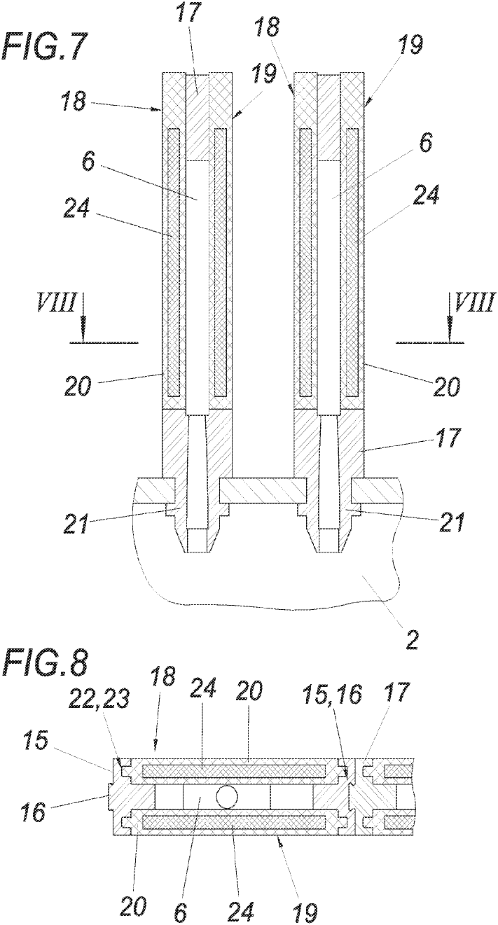

FIG. 7 shows a vertical section through the filter elements of the second embodiment of the apparatus according to the invention, and

FIG. 8 shows a section along line VIII-VIII of FIG. 7.

### DETAILED DESCRIPTION OF THE PREFERRED EMBODIMENTS

As can be seen from FIG. 1, an apparatus for continuous filtration of a suspension has a housing 1 in which a hollow shaft 2 is rotatably mounted. As is disclosed in particular in FIG. 4, the hollow shaft 2 is flow-connected to a plurality of discoid filter elements 3 projecting radially from the hollow shaft 2. This can be achieved by the hollow shaft 2 being flow-connected via apertures 4 to an inner chamber 6 surrounded by a filter membrane 5. If a suspension flows against the filter element 3, the solid particles are retained by the filter membrane 5, while the liquid component penetrates the filter membrane 5, flows into the inner chamber 6 and leaves the apparatus as filtrate via the hollow shaft 2. The driving force of filtration is the pressure difference between the suspension side and the filtrate side. The higher this pressure difference, the faster the filtration. To further increase the pressure difference, an additional pump can be provided on the suspension side and/or a vacuum pump on the filtrate side. In the course of filtration, a filter cake forms on the filter membrane 5 due to the retained solid particles, which forms a flow resistance and therefore reduces the filtration performance or filtration efficiency with increasing thickness. Therefore, the filter cake must be cleaned off regularly. However, increasing the pressure on the suspension side, which is desirable in order to generate a large driving force for filtration, also results in compaction of the filter cake that has formed, making it more difficult to clean it off. Therefore, to enable a large driving force of filtration and thus a high filtration efficiency, the radius r of the filter element 3 increases in the circumferential direction from a low-pressure radius rₗ to a high-pressure radius rₕ to reduce the free housing cross-section, as disclosed in FIG. 3. As a result, the free housing cross-section changes as the filter elements rotate, causing the suspension at a space-fixed reference point to be subjected to a pressure profile that changes over time. As the free cross-section narrows, the pressure differential between the suspension side and the filtrate side increases, favoring rapid filtration. As the free cross-section increases, the pressure difference between the suspension side and the filtrate side decreases. Due to these constant pressure fluctuations, the filter cake is loosened and can detach from the filter membrane. The centrifugal force generated by the rotation of the filter elements 3 can further improve the cleaning effect. A rapid pressure drop can also promote cleaning. This can be achieved if the filter element 3 has a compression section 7 formed starting from the low-pressure radius rᵢ by increasing the radius r of the filter element 3 to the high-pressure radius rₕ, and an expansion section 8 formed starting from the high-pressure radius rₕ by decreasing the radius r of the filter element 3 to the low pressure rᵢ, wherein the decrease of the radius r in the expansion section 8 is faster than the increase in the compression section 7. Accordingly, the expansion section 8 occupies a smaller sector of the disk-shaped filter element 3 than the compression section 7.

In order to achieve a varying pressure distribution in the axial direction as well, several filter elements 3 can be arranged on the hollow shaft 2, the high-pressure radii rₕ of which are offset from one another in a circumferential direction. As can be seen from FIG. 3, a filter element 3 is always offset in the same circumferential direction to the previous filter element 3, so that the filter elements 3 form a spiral running around the hollow shaft 2. Particularly favorable conditions result when the offset of the high-pressure radii rₕ between two filter elements 3 following one another in the axial direction is between 1° and 45°. The offset can be 10°, for example, as shown in the exemplary embodiment. FIG. 5 shows the schematic pressure curve generated by the offset of the filter elements 3 along an axial exemplary flow line (not drawn) extending along the length of the apparatus at a specific point in time. While the pressure 9 on the filtrate side remains constant, the pressure 10 on the suspension side exhibits an undulating course due to the offset of the filter elements 3 in the axial direction and thus due to the different sizes of the free cross-sectional areas. The pressure increasing over the length is accompanied by the increasing solids content of the suspension. The areas with large pressure difference δpₕ favor a high filtration rate. The areas with small pressure difference δpₗ favor effective cleaning of the filter cake. In addition, the regular change in pressure differences creates turbulence, which further enhances the cleaning of the filter cake, resulting in an overall increase in filtration efficiency. It should be noted that the pressure curve shown in FIG. 5 corresponds to the pressure curve along a flow line at a fixed point in time. Due to the constant rotation of the hollow shaft 2, there is naturally a phase shift in the pressure curve over time.

As shown in particular in FIG. 2, at least two hollow shafts 2 extending parallel to each other can be provided in the housing 1, the filter elements 3 of which are offset in the axial direction towards each other to form a gap. As a result, particularly large housing cross-sections can also be used for high throughput without requiring special fabrications with regard to the size of the filter elements 3. This also allows geometrically more complex housing cross-sections to be used and fitted with filter elements.

The filter elements 3, which are staggered with respect to each other, can also overlap at least partially, forming an overlap area 11 which is variable in time by the rotation. As a result, a corresponding relative movement of the hollow shafts 2 can lead both to mutual shearing of the filter cakes of adjacent filter elements 3 located on the filter membranes 5 and to an increase in turbulence in the suspension. The filter elements 3 arranged according to the invention also act as a crushing or mixing unit for any inhomogeneities in the suspension.

In order that the suspension can also be actively and uniformly conveyed by the apparatus according to the invention, the hollow shafts 2, as disclosed for example in FIGS. 1 to 3, with the filter elements 3 arranged thereon, can be arranged relative to one another about a common plane of symmetry. With the hollow shafts moving accordingly at the same speed but in opposite directions, the suspension is actively pressed in the axial direction, which means that no further conveying devices are required.

For making up the filtered suspension, a pelletizing plate 12 can be used, which is arranged downstream of the filter elements 3 and is also driven by the hollow shaft 2.

The suspension can be fed in or discharged via connection pipes 13.

As can be seen from FIG. 6, a filter element 3 can comprise several filter element segments 14 in each case. The filter element segments 14 can be detachably connected to one another via a form fit to form the filter element 3. For example, the filter element segments 14 can be releasably connected to one another via a tongue-and-groove connection 15, 16 extending in the radial direction.

As can be seen from FIGS. 6 to 8, in particular from FIGS. 7 and 8, a filter element segment 14 can have a fluid-impermeable base body 17 into which two filter membrane disks 20 acting as cover or bottom surfaces 18, 19 are inserted. Together with the filter membrane disks 20, the base body 17 spans the cavity 6 of the filter element segment 14. The filter element segments 14 can be detachably flow-connected to the hollow shaft 2 via connecting nipples 21. The filter membrane disks 20 can in turn be detachably connected to the base body 17 via a tongue-and-groove connection 22, 23 (FIG. 8).

The filter membrane disks 20 may be made of porous plastic. In addition, the filter membrane disks 20 may comprise a ceramic core 24.

1. An apparatus for continuous filtration of a sludge suspension, said apparatus comprising:
a hollow shaft rotatably mounted in a housing and flow-connected to the an inner chamber, said inner chamber being surrounded by a filter membrane having a discoid filter element that radially projects from the hollow shaft;
wherein the discoid filter element has a radius that increases in the a circumferential direction from a low-pressure radius to a high-pressure radius so as to reduce the a free housing cross-sections; and
wherein the filter element has
a compression section defined by an increase of the radius of the filter element from the low-pressure radius to the high-pressure radius, and
an expansion section defined by a decrease of the radius of the filter element from the high-pressure radius to the low-pressure radius; and
wherein the decrease of the radius in the expansion section is faster than the increase of the radius in the compression section.

2. The apparatus according to claim 1, wherein the filter element is one of a plurality of filter elements arranged on the hollow shaft in an axial direction, the filter elements having respective high-pressure radii that are offset from one another in a circumferential direction.

3. The apparatus according to claim 2, wherein the the high-pressure radii between two of the filter elements following one another in the axial direction is are offset between 1° and 45°.

4. The apparatus according to claim 1, wherein the hollow shaft is one of at least two mutually parallel hollow shafts provided in the housing, each of the hollow shafts having the filter elements that are staggered with respect to one another in the axial direction.

5. The apparatus according to claim 4, wherein the filter elements of the mutually parallel hollow shafts at least partially overlap in the axial direction.

6. The apparatus according to claim 4, wherein the hollow shafts with the filter elements arranged thereon are arranged mirrored relative to one another about a common plane of symmetry.

7. The apparatus according to claim 1, wherein a pelletizing device driven by the hollow shaft is supported downstream of the filter elements.

8. The apparatus according to claim 1, wherein the filter element comprises a plurality of filter element segments detachably connected to one another.

9. The apparatus according to claim 8, wherein the filter element segments are of porous plastic.

10. The apparatus according to claim 1, wherein the filter membrane has two filter membrane disks arranged parallel to one another at a distance.

11. The apparatus according to claim 10, wherein the filter membrane disks are inserted into a fluid-impermeable base body of the filter element segment.

12. The apparatus according to claim 10, wherein the filter membrane disks are of porous plastic.

13. The apparatus of claim 10 wherein the filter membrane disks each comprise a ceramic core .

14. The apparatus according to claim 2, wherein the hollow shaft is one of at least two mutually parallel hollow shafts provided in the housing, each of the hollow shafts having filter elements that are staggered with respect to one another in the axial direction.

15. The apparatus according to claim 3, wherein the hollow shaft is one of at least two mutually parallel hollow shafts provided in the housing, each of the hollow shafts having filter elements that are staggered with respect to one another in the axial direction.

16. The apparatus according to claim 15, wherein the filter elements of the mutually parallel hollow shafts at least partially overlap in the axial direction; and
wherein the hollow shafts with the filter elements arranged thereon are arranged mirrored relative to one another about a common plane of symmetry.
